(19) United States
(12) Patent Application Publication
(10) Pub. No.: US 2026/0172077 A1
(43) Pub. Date: Jun. 18, 2026

(54) CHANNEL STATE INFORMATION GENERATION AND CONFIGURATION METHODS AND APPARATUSES AND COMMUNICATION SYSTEM

(71) Applicant: 1FINITY Inc., Kawasaki-shi (JP)

(72) Inventors: Qun ZHANG, Beijing (CN); Xin WANG, Beijing (CN); Liqiang JIN, Beijing (CN); Lei ZHANG, Beijing (CN)

(73) Assignee: 1FINITY Inc., Kawasaki-shi (JP)

(21) Appl. No.: 19/531,475

(22) Filed: Feb. 5, 2026

Related U.S. Application Data
(63) Continuation of application No. PCT/CN2023/112405, filed on Aug. 10, 2023.

(51) Int. Cl. H04B 7/0417; H04B 7/06

(52) U.S. Cl. CPC H04B 7/0417; H04B 7/063; H04B 7/0626

(57) ABSTRACT

A channel state information generation apparatus, applicable to a terminal equipment, includes: first processor circuitry controlling the terminal equipment, the first processor circuitry configured to: receive a first configuration by the terminal equipment from a network device, the first configuration being used to configure the terminal equipment to transmit channel state information (CSI) to the network device, and the first configuration comprising model information and/or bitwidth information associated with precoding matrix information; and generate the CSI by the terminal equipment according to a model, the model being determined at least according to the first configuration, and the CSI at least comprising the precoding matrix information.

### CROSS-REFERENCE TO RELATED APPLICATION

This application is a continuation application under 35 U.S.C. 111(a) of International Patent Application PCT/CN2023/112405 filed on Aug. 10, 2023, and designated the U.S., the entire contents of which are incorporated herein by reference.

### TECHNICAL FIELD

This disclosure relates to the field of communication technologies.

### BACKGROUND

Multiple-input multiple-output (MIMO) technology is one of the key technologies for 5G mobile communication. MIMO is able to provide higher channel capacity, but the acquisition of the benefits depends on whether accurate channel state information may be acquired.

In the MIMO technology, a terminal equipment measures spatial channels and feeds channel state information (CSI) back to a network device. According to the channel state information reported by the terminal equipment, the network device may select an appropriate precoding matrix suitable for the terminal equipment in performing downlink transmission, thereby reducing a probability of receiving bit errors of the terminal equipment as much as possible.

A channel state information generation and feedback process may be summarized as follows. The network device transmits channel state information reference signals (CSI-RSs) to terminal equipments, and the terminal equipments estimate channels based on the received CSI-RSs to obtain estimation of a spatial channel matrix. The terminal equipments further utilize the estimated spatial channels to obtain CSI. In the New Radio (NR) technology, a feedback mode of CSI is implicit feedback, that is, the terminal equipments provide CSI in a form of recommending transmission parameters to the network device, the transmission parameters including a channel quality indicator (CQI), a precoding matrix indicator (PMI), a CSI-RS resource indicator (CRI), a synchronization signal block resource indicator (SSBRI), a layer indicator (LI), a rank indicator (RI), and physical layer RSRP (L1-RSRP), etc. A base station may directly use the parameters recommended by the terminal equipment to perform downlink transmission, or, it may not use the recommended parameters.

In a frequency division duplex (FDD) system, for a downlink, when the network device uses information of downlink channels for precoding, the terminal equipment is needed to feed back the downlink channel state information to the network device via an uplink. However, as the information of downlink channels is proportional to the number of antennas of the network device, in a scenario of massive MIMO, the huge number of antennas of the network device will lead to a very large amount of feedback on the channel state information of the downlink channels. Enhanced codebooks (such as eType II codebooks) for downlink feedback have been designed in the Third Generation Partnership Project (3GPP), in which feedback amount of channel state information is reduced through frequency domain compression. However, for valuable uplink resources, there is still a need to further reduce the amount of uplink feedback.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

With the development of artificial intelligence/machine learning (AI/ML) technologies, applying the AI/ML technologies to physical layers of wireless communication to solve difficulties in related methods has become a current technological direction.

FIG. 1 is a schematic diagram of CSI feedback based on AI/ML. An AI/ML module may include an AI/ML-based CSI generation portion and an AI/ML-based CSI reconstruction portion, wherein the AI/ML-based CSI generation portion includes an AI/ML model, the AI/ML model including an AI/ML encoder and a quantizer. In addition, and further including a preprocessing module. The AI/ML-based CSI reconstruction portion includes an AI/ML reconstruction model, the AI/ML reconstruction model including a quantizer and an AI/ML decoder, and further including a post-processing module.

As shown in FIG. 1, in operation 101, the terminal equipment side uses the AI/ML-based CSI generation portion to process and obtains CSI, and the network device receives the CSI via air interface; and in operation 102, the network device uses the AI/ML-based CSI reconstruction portion to process the received CSI, and obtains recovered CSI.

It was found by the inventors that in the related art, the CSI report configuration only supports CSI generated based on codebooks, and relevant information for configuring a CSI bitwidth is realized implicitly by codebook configuration. For technical solutions where the CSI is generated by using an AI/ML model, how to perform CSI report configuration is a problem needing to be solved.

In order to solve at least one of the above problems or other similar problems, embodiments of this disclosure provide channel state information generation and configuration methods and apparatuses and a communication system. In the methods, a terminal equipment receives a first configuration corresponding to a model transmitted by a network device, so as to perform configuration associated with CSI reporting on the terminal equipment, and furthermore, the terminal equipment may generate CSI according to a model corresponding to the first configuration.

According to one aspect of the embodiments of this disclosure, there is provided a channel state information generation apparatus, applicable to a terminal equipment, the apparatus including a first processing unit, the first processing unit controlling the terminal equipment to execute the following operations:
receiving a first configuration by the terminal equipment from a network device, the first configuration being used to configure the terminal device to transmit channel state information (CSI) to the network device, and the first configuration comprising model information and/or bitwidth information associated with precoding matrix information; and
generating the CSI by the terminal equipment according to a model, the model being determined at least according to the first configuration, and the CSI at least comprising the precoding matrix information.

According to another aspect of the embodiments of this disclosure, there is provided a channel state information configuration apparatus, applicable to a network device, the apparatus including a second processing unit, the second processing unit controlling the network device to execute the following operations:
transmitting a first configuration by the network device to a terminal device, the first configuration being used to configure the terminal device to transmit channel state information (CSI) to the network device, and the first configuration comprising model information and/or bitwidth information associated with precoding matrix information,
the CSI being generated by the terminal equipment according to a model, the model being determined at least according to the first configuration, and the CSI at least comprising the precoding matrix information.

An advantage of the embodiments of this disclosure exists in that the terminal equipment receives the first configuration corresponding to the model transmitted by the network device, so as to perform configuration associated with CSI reporting on the terminal equipment, and furthermore, the terminal equipment may generate CSI according to a model corresponding to the first configuration.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in more than one other embodiments and/or in combination with or instead of the features of the other embodiments.

It should be emphasized that the term “includes/including” when used in this specification is taken to specify the presence of stated features, integers, steps or components but does not preclude the presence or addition of more than one other features, integers, steps, components or groups thereof.

### BRIEF DESCRIPTION OF THE DRAWINGS

Elements and features depicted in one drawing or embodiment of the disclosure may be combined with elements and features depicted in more than one additional drawings or embodiments. Moreover, in the drawings, like reference numerals designate corresponding parts throughout the several views and may be used to designate like or similar parts in more than one embodiments.

FIG. 1 is schematic diagram of performing CSI feedback based on AI/ML;

FIG. 2 is a schematic diagram of a communication system of this disclosure;

FIG. 3 is a schematic diagram of a channel state information generation method of an embodiment of a first aspect of this disclosure;

FIG. 4 is a schematic diagram of a channel state information configuration method of an embodiment of a second aspect of this disclosure;

FIG. 5 is a schematic diagram of a channel state information generation apparatus of an embodiment of a third aspect of this disclosure;

FIG. 6 is a schematic diagram of a channel state information configuration apparatus of an embodiment of a fourth aspect of this disclosure;

FIG. 7 is a schematic diagram of a terminal equipment of an embodiment of a fifth aspect of this disclosure; and

FIG. 8 is a schematic diagram of a network device of the embodiment of the fifth aspect of this disclosure.

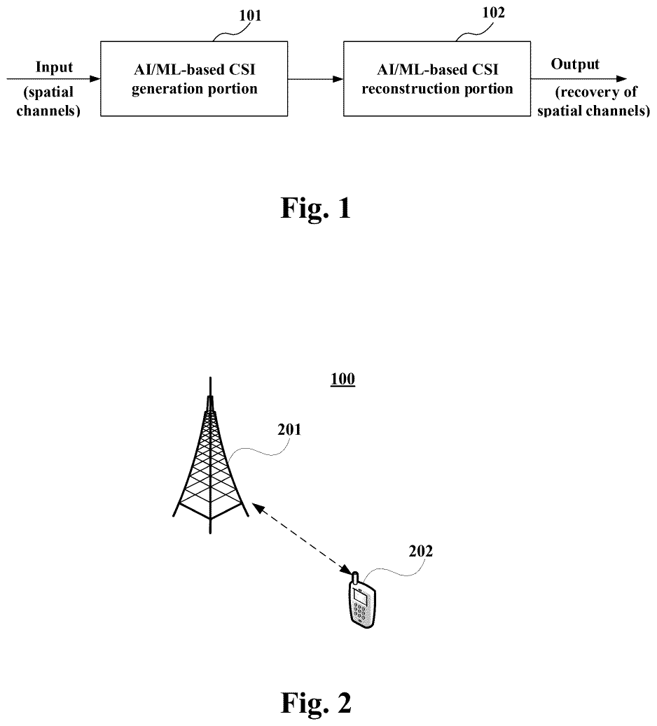

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of more than one relevantly listed terms. Terms “contain”, “include” and “have” refer to existence of stated features, elements, components, or assemblies, but do not exclude existence or addition of more than one other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

Wherein, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or at least one network device including those described above. The term “user side” or “terminal side” or “terminal equipment side” refers to a side of a user or a terminal, which may be a UE, and may include at least one terminal equipments described above.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, high-layer signaling may be, for example, radio resource control (RRC) signaling; for example, it is referred to an RRC message, which includes an MIB, system information, and a dedicated RRC message; or, it is referred to an as an RRC information element (RRC IE). High-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

FIG. 2 is a schematic diagram of a communication system of this disclosure, in which a case where a terminal equipment and a network device are taken as examples is schematically shown. As shown in FIG. 2, the communication system 100 may include a network device 201 and a terminal equipment 202 (for the sake of simplicity, an example having only one terminal equipment is schematically given in FIG. 2).

In the embodiment of this disclosure, existing traffics or traffics that may be implemented in the future may be performed between the network device 201 and the terminal equipment 202. For example, such traffics may include but not limited to enhanced mobile broadband (eMBB), massive machine type communication (MTC), and ultra-reliable and low-latency communication (URLLC), etc.

The terminal equipment 202 may transmit data to the network device 201, such as in a grant or grant-free manner. The network device 201 may receive data transmitted by at least one terminal equipments 202, and feed back information to the terminal equipment 202, such as acknowledgement (ACK)/non-acknowledgement (NACK) information, and the terminal equipment 202 may acknowledge to terminate a transmission process, or may perform transmission of new data, or may perform data retransmission.

In the following description of this disclosure, an artificial intelligence (AI) model may also be referred to as an artificial intelligence/machine learning (AI/ML) model, and they are interchangeable.

In the embodiments described below, signaling transmitted by the network device to the terminal equipment may be transmitted via downlink control information (DCI), a media access control control element (MAC CE), and/or radio resource control (RRC) signaling.

In the following embodiments of this disclosure, there exists a pairing relationship between an AI/ML-based CSI generation portion and an AI/ML-based CSI reconstruction portion, the former being applicable to a terminal equipment side, and the latter being applicable to a network device side. If the terminal equipment uses an AI/ML-based CSI generation portion, the network device uses an AI/ML-based CSI reconstruction portion paired with the AI/ML-based CSI generation portion to successfully reconstruct channel information. And if the network device uses an AI/ML-based CSI reconstruction portion, the terminal equipment uses an AI/ML-based CSI generation portion paired with the AI/ML-based CSI reconstruction portion to successfully reconstruct channel information at the network device side.

The AI/ML-based CSI generation portion includes a first AI/ML model, i.e. an AI/ML-based CSI generation model, which may be used to generate at least one of precoding matrix information, a rank indicator (RI), a layer indicator (LI), a channel resource indicator (CRI), and a channel quality indicator (CQI). In addition, the RI, LI, CRI and CQI may not be generated by the AI/ML model. For example, the AI/ML-based CSI generation portion may further include at least one of a module generating an RI, a module generating an LI, a module generating a CRI, and a module generating a CQI. The AI/ML-based CSI generation portion may further include other modules, such as a module for truncating bit sequences.

The information of the AI/ML-based CSI generation portion may be composed of AI/ML model information and/or information of the module generating an RI and/or information of the module generating an LI and/or information of the module generating a CRI and/or information of the module generating a CQI and/or information of a module truncating a bit sequence and/or information of other functional modules (if any).

The first AI/ML model may include three parts, a preprocessing module, an AI/ML encoder and a quantizer. Therefore, AI/ML model information may include preprocessing module information, AI/ML encoder information and quantizer information. For example, the AI/ML model information may be described by “preprocessing module #2, AI/ML encoder #4, quantizer #A”. In addition, the preprocessing module, AI/ML encoder and quantizer may be regarded as a whole to annotate the AI/ML model information, that is, the AI/ML model information may also be expressed as, for example, AI/ML model information #4, etc.

The AI/ML-based CSI reconstruction portion includes a second AI/ML model (also referred to as an AI/ML reconstruction model). The second AI/ML model may include three parts, a dequantizer, an AI/ML decoder, and a post-processing module. Therefore, the AI/ML reconstruction model information may include dequantizer information, AI/ML decoder information, and post-processing module information. For example, the AI/ML reconstruction model information may be described by “dequantizer #B, AI/ML decoder #1, post-processing module #2”. In addition, the AI/ML reconstruction model information may also be expressed as, for example, AI/ML reconstruction model #1, or AI/ML model #1 in brief, so as to express the pairing relationship with AI/ML model #1 in the AI/ML-based CSI generation portion.

The first AI/ML model and the second AI/ML model are in a pairing relationship.

In some embodiments, the first AI/ML model may also be composed of two parts (for example, it has no preprocessing module, or a preprocessing module is included in the AI/ML encoder and is regarded as a whole with the AI/ML encoder), that is, the first AI/ML model includes an AI/ML encoder and a quantizer. Under such circumstances, the AI/ML model information may be composed of AI/ML encoder information and quantizer information. The second AI/ML model paired with the first AI/ML model may also consist of two parts, a quantizer and an AI/ML decoder. Under such circumstances, the AI/ML reconstruction model information consists of quantizer information and AI/ML decoder information. The preprocessing module may be included in the AI/ML encoder, or may not be included in the AI/ML encoder. The post-processing module may be included in the AI/ML decoder or may not be included in the AI/ML decoder.

In some other embodiments, the first AI/ML model may also be composed of one part, that is, the AI/ML encoder and quantizer are regarded as a whole (for example, the AI/ML encoder and quantizer are inseparable and cannot be freely combined), and the AI/ML encoder may or may not include a preprocessing module. Under such circumstances, the AI/ML model information consists of one part only, for example, the AI/ML model information is AI/ML model #5. The second AI/ML model may also be composed of one part, that is, the dequantizer and AI/ML decoder are regarded as a whole (for example, the AI/ML decoder and dequantizer are inseparable and cannot be freely combined), and the AI/ML decoder may or may not include a post-processing module. Under such circumstances, the AI/ML reconstruction model information consists of one part only, for example, the AI/ML reconstruction model information is AI/ML reconstruction model #5, or AI/ML model #5 in brief, so as to express the pairing relationship with AI/ML model #5 in the AI/ML-based CSI generation portion.

In the embodiments of this disclosure, the first AI/ML model and the second AI/ML model may be collectively referred to as AI/ML models, that is, an AI/ML model may include the first AI/ML model, or the second AI/ML model, or paired first AI/ML model and second AI/ML model.

The embodiments of this disclosure satisfy the following conditions based on the following scenarios where:
1. the terminal equipment and network device have completed pairing of AI/ML models, that is, the first AI/ML model supported by the terminal equipment has been paired with the second AI/ML model supported by the network device; and
2. after pairing the AI/ML models, a bitwidth of output of each AI/ML-based generation model (e.g. a bitwidth associated with precoding matrix information) corresponds only to one first AI/ML model (i.e. the AI/ML-based generation model).

In various embodiments of this disclosure, reporting may refer to an action of transmitting information by the terminal equipment to the network device. For example, reporting a CSI report by the terminal equipment may refer to transmitting a CSI report by the terminal equipment to the network device.

### Embodiment of a First Aspect

The embodiment of the first aspect provides a channel state information generation method, applicable to a terminal equipment, such as the terminal equipment 202 in FIG. 2.

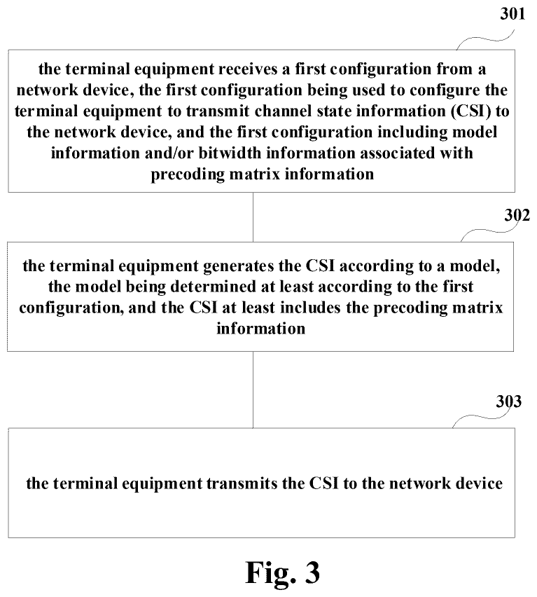

FIG. 3 is a schematic diagram of the channel state information generation method of the embodiment of the first aspect. As shown in FIG. 3, the method includes:
operation 301: the terminal equipment receives a first configuration from a network device, the first configuration being used to configure the terminal equipment to transmit channel state information (CSI) to the network device, and the first configuration including model information and/or bitwidth information associated with precoding matrix information; and
operation 302: the terminal equipment generates the CSI according to a model, the model being determined at least according to the first configuration, and the CSI at least comprising the precoding matrix information.

According to the embodiment of the first aspect, the terminal equipment receives the first configuration corresponding to the model transmitted by the network device, so as to perform configuration related to CSI reporting on the terminal equipment, and furthermore, the terminal equipment may generate CSI according to a model corresponding to the first configuration.

As shown in FIG. 3, the method may further include:
operation 303: the terminal equipment transmits the CSI to the network device.

In some embodiments, the first configuration in operation 301 includes at least one of the following configurations: a CSI report configuration, a physical uplink control channel configuration, a physical uplink shared channel configuration, and a configuration about uplink control information.

In some embodiments, the precoding matrix information is associated with spatial layer information.

The bitwidth information associated with precoding matrix information includes:
a bitwidth of the precoding matrix information, and/or an index of the bitwidth of the precoding matrix information, and/or a maximum value of the bitwidth of the precoding matrix information, and/or an index of the maximum value of the bitwidth of the precoding matrix information.

In some embodiments, the network device may directly configure the bitwidth information associated with precoding matrix information via the first configuration.

In some other embodiments, the network device may implicitly configure the bitwidth information associated with precoding matrix information via the first configuration.

For example, the network device may configure (e.g. via the first configuration) a bitwidth of the CSI and/or a maximum value of the bitwidth of the CSI; the network device further configures (e.g. via the first configuration) a CSI report quantity (reportQuantity), the CSI report quantity including the precoding matrix information; bitwidths of other information in the CSI report quantity than the precoding matrix information are given in standards and/or may be obtained according to the standards. In this way, the bitwidth of the precoding matrix information and/or the maximum value of the bitwidth of the precoding matrix information is/are equal to the bitwidth of the CSI configured by the network device and/or the maximum value of the bitwidth of the CSI subtracted by a sum of the bitwidths of other information in the CSI report quantity than the precoding matrix information. Thus, the bitwidth of the precoding matrix information and/or the maximum value of the bitwidth of the precoding matrix information may be implicitly configured.

In operation 302, the model may be an artificial intelligence model, such as the above-mentioned AI/ML model.

In some embodiments of operation 302, the model is determined at least according to the first configuration. For example, the model is set by the first configuration, and/or the model is determined by the terminal equipment according to the first configuration.

In operation 302, the terminal equipment may generate the CSI according to the model, and the CSI at least comprises the precoding matrix information. For example, the precoding matrix information in the CSI may be generated by the model.

This disclosure shall be further described below with reference to embodiments. In the following embodiments, the precoding matrix information may also be referred to as first information, and the CSI generated by the terminal equipment according to the model may also be referred to as second information, wherein the first information is a part of the second information.

### Embodiment 1

In embodiment 1, in addition to including the model information and/or the bitwidth information related to the precoding matrix information, the first configuration further instructs the terminal equipment to report a rank indicator, and the CSI further includes the rank indicator.

In some implementations, the terminal equipment further receives third information transmitted by the network device.

For example, the terminal equipment receives a second configuration transmitted by the network device, the second configuration including third information and/or antenna port information, the third information being used to limit the rank indicator (RI) in the CSI and/or a value to which the rank indicator corresponds. The second configuration is used to provide configurations for generating the first information and/or the second information. At least a part of the first configuration is the second configuration, or, the first configuration does not include the second configuration.

For another example, the third information is included in a third configuration, the third configuration including configurations for generating the precoding matrix information and/or the CSI. The third configuration is included in the second configuration, or, the third configuration is not included in the second configuration.

For example, the third information may be included in the first configuration.

Embodiment 1 shall be further described below by way of examples.

The network device transmits the first configuration to the terminal equipment, and in addition to including the model information and/or the bitwidth information associated with the precoding matrix information, the first configuration further indicates that the second information reported by the terminal equipment includes a rank indicator.

In some implementations, the first configuration further includes the third information. The third information is used to restrict the rank indicator in the second information, for example, the third information may be a rank indicator (RI) restriction parameter. The first configuration may be at least one of the following configurations: a CSI report configuration, a physical uplink control channel configuration, a physical uplink shared channel configuration, and a configuration about uplink control information (UCI). The third information may be given by a bitmap, or may be given by an index.

In the case where the first configuration includes a CSI report configuration, a configuration includes not only configurations for a CSI report quantity, time-domain characteristics, and frequency-domain characteristics, etc. (such as configurations applicable to various methods for generating CSI (traditional codebooks, AI), related technical configurations), but also configurations for AI/ML models that generate precoding matrix information according to AI/ML methods, and/or configurations for bitwidths of precoding matrix information and/or a maximum value of the bitwidths, and configurations for methods for using AI/ML models (all spatial layers use identical AI/ML models, and at least two spatial layers use different AI/ML models, etc.). Such an implementation has advantages of control signaling saving and simple operation.

In the case where the first configuration includes at least one of a physical uplink control channel configuration, a physical uplink shared channel configuration and a configuration about uplink control information, following benefits may be achieved that “a configuration of the AI/ML model for generating precoding matrix information, and/or a configuration of a bitwidth of the precoding matrix information and/or a maximum value of the bitwidth and a configuration of a method for using the AI/ML model (all spatial layers use identical AI/ML models, and at least two spatial layers use different AI/ML models, etc.)” is configured independently of the CSI report configuration. When the configurations of these contents are modified, there is no need to modify contents in the CSI report configuration, which is beneficial for flexibly configuring the AI/ML method to generate CSI, and there is no need to retransmit contents of not modifying the CSI report configuration, thereby saving signaling overhead.

In some implementations, the first configuration includes a second configuration, the second configuration includes configurations for generating the first information and/or the second information. In this example, the second configuration is named CodebookConfig-ai, and may also be in other names. The third information may be included in the second configuration. In this example, the third information may be named AI-RI-Restriction in an information element (IE), and may also be in other names. In this implementation, the second configuration and the third information are configurations of the precoding matrix information and rank indicator restriction information needed in the scenario of generating CSI in an AI/ML-based method, and a mode of providing them is similar to a logical relationship between the configuration of the precoding matrix information and information on a rank indicator restriction in generating CSI by using codebooks. An advantage of such an implementation is introducing variables in the scenario where CSI is generated based on the AI/ML method similar to those in a scenario where CSI is generated according to a codebook method to implement similar functions, with modifications to the standards as small as possible, thereby reducing complexity of understanding and implementing the standards. Another advantage is that in manufacturing products, an implementation logic is similar to a corresponding part in generating CSI by using codebooks, making it easy for product design, implementation and manufacture.

Tables 1 and 2 below give a specific example. This example gives a method for defining an information element (IE) for configuring third information.

TABLE 1
-- ASN1START
-- TAG-CSI-REPORTCONFIG-START

| | |
|---|---|
| CSI-ReportConfig ::= | SEQUENCE { |
| reportConfigID | CSI-ReportConfigId, |
| carrier | ServCellIndex OPTINAL, |

--Need S
...,

| | |
|---|---|
| codebook-config-ai | Codebook Config-ai |

OPTIONAL, --Need R/S/M
}
-- TAG-CSI-REPORTCONFIG-STOP
-- ASN1STOP

TABLE 2
-- ASN1START
-- TAG-CODEBOOKCONFIG-AI-START

| | |
|---|---|
| CodebookConfig-ai ::= | SEQUENCE { |
| codebookType | CHOICE{ |
| ai | SEQUENCE{ |
| subtype | CHOICE{ |
| AI | SEQUENCE{ |
| ..., | |
| AI-RI-Restriction | BIT STRING (SIZE(4)) |

```
          },
          ...
        },
        ...
      },
      ...
  },
  ...
}
-- TAG- CODEBOOKCONFIG-AI -STOP
-- ASN1STOP
```

In some implementations, the first configuration does not include the second configuration. In these implementations, the configurations for generating the first information and/or the second information are configured separately from the first configuration, and an example is that the second configuration is not in the CSI report configuration. An advantage of such an implementation is that on-demand configuration may be achieved, flexibility of generating CSI based on an AI/ML method may be enhanced, and supporting and implementing rich and diverse functions are made easy. Another advantage of such an implementation is that the configuration required for generating CSI based on AI/ML may be provided separately, that is, independently of all configurations applicable to generating CSI (such as generating CSI by using a codebook method). This is beneficial for clearly describing characteristics of using AI/ML to generate CSI, making it easy to find modifications introduced by AI/ML features in the standards, making the standards clear and easy to understand. It also makes it clearer to modify AI/ML configurations, minimizing the risk of erroneous operations on non-AI/ML feature parameters caused by modifying AI/ML parameters and variables.

In some implementations, the third information is not included in the second configuration. An advantage of such an implementation is supporting more flexible configuration of the third information. One example is that the third information is included in the third configuration, and the third configuration is not included in the second configuration. When it is needed to change the configuration of the rank indicator restriction, there is no need to retransmit the entire configuration for generating CSI, but only change the configuration of the third information, thereby saving signaling overhead.

Furthermore, in a case where the third information is included in the third configuration, the third configuration may also be included in the second configuration. An advantage of such an implementation is introducing variables in the scenario where CSI is generated according to the AI/ML method similar to those in a scenario where CSI is generated according to a codebook method to implement similar functions, with modifications to the standards as small as possible, thereby reducing complexity of understanding and implementing the standards. Another advantage is that in manufacturing products, an implementation logic is similar to a corresponding part in generating CSI by using codebooks, making it easy for product design, implementation and manufacture.

The above description of embodiment 1 is applicable to any of the following embodiments, that is, embodiment 1 may be executed separately, or may be executed in combination with any of the following embodiments.

### Embodiment 2

In embodiment 2, the first configuration includes at least one type of bitwidth information and/or model information.

Following description shall be given by taking a case where the first configuration includes the bitwidth information as an example.

In some implementations, the network device configures a bitwidth of the first information. This configuration is included in the CSI report configuration. Based on the scenario of this disclosure, there is a model available for the terminal equipment. For a value to which each possible rank indicator corresponds, the terminal equipment generates CSI by using the model for all spatial transport layers, such as generating the first information and/or the second information.

Table 3 below gives a specific example. This example gives a method for configuring a bitwidth.

TABLE 3

| -- ASN1START | |
|---|---|
| -- TAG-CODEBOOKCONFIG-AI-START | |
| CodebookConfig-ai ::= | SEQUENCE { |
| codebookType | CHOICE{ |
| payloadSize-ai | INTEGER(1 .. 8), |

```
      ...
  },
  ...
}
-- TAG- CODEBOOKCONFIG-AI -STOP
-- ASN1STOP
```

In Table 3 above, a configuration for the bitwidth of the first information is added, which may be an index named “payloadSize-ai” or may be in other names. In Table 3 above, it is assumed that there are a total of 8 pairs of AI/ML models after the terminal equipment and the network device are paired, that is, there are 8 possibilities for the bitwidth of the supported first information, which may be described by using 3 bits, as shown in Table 4 below.

TABLE 4

| Bitwidth of the first | | Bit representation |
|---|---|---|
| information (bits) | Index | of the index |
| 120 | 1 | 000 |
| 110 | 2 | 001 |
| 100 | 3 | 010 |
| 95 | 4 | 011 |
| 90 | 5 | 100 |
| 82 | 6 | 101 |
| 80 | 7 | 110 |
| 70 | 8 | 111 |

For example, the bit representation of the index of the bitwidth of the first information given by the network device in the CSI report configuration is “100”, which means that the network device configures that the terminal equipment reports that the index of the bitwidth of the first information is 5, corresponding to 90 bits.

In embodiment 2, reference may be made to relevant technologies for a format of the CSI report transmitted by the terminal equipment via an uplink channel.

### Embodiment 3

In embodiment 3, the first configuration includes at least two types of bitwidth information and/or model information, wherein the precoding matrix information of at least one spatial layer is configured with at least one type of bitwidth information and/or model information.

Following description shall be given by taking a case where the first configuration includes bitwidth information (such as a bitwidth and/or a maximum value of the bitwidth) as an example.

In some implementations, the network device configures at least two types of bitwidths of the first information. The configurations are included in the CSI report configuration (i.e. the first configuration). The network device configures bitwidths and/or a maximum value of the bitwidths of at least one type of the first information for each spatial layer. The number of the spatial layers is equal to a value to which the third information corresponds.

In some implementations, the network device configures a bitwidth and/or a maximum value of the bitwidth of the first information for each spatial layer. The bitwidths and/or the maximum values of the bitwidths may be identical, or at least two of them are different. In this case, the terminal equipment generates CSI by using a corresponding AI/ML model according to the configuration. For example, the network device configures information shown in Table 5 below, a value to which the third information corresponds is 4, and a value to which the RI obtained by the terminal equipment corresponds is 2, then the terminal equipment generates first information of a spatial layer with an index 1 by using an AI/ML model to which 120 bits correspond, and generates first information of a spatial layer with an index 2 by using an AI/ML model to which 100 bits correspond.

TABLE 5

| | Bitwidth and/or a maximum |
|---|---|
| Index of a | value of the bitwidth of |
| spatial layer | the first information |
| 1 | 120 bits |
| 2 | 100 bits |
| 3 | 80 bits |
| 4 | 70 bits |

For another example, the network device configures information shown in Table 6 below, a value to which the third information corresponds is 6, and a value to which the RI obtained by the terminal equipment corresponds is 6, then the terminal equipment generates first information of a spatial layer with an index 1 by using an AI/ML model to which 120 bits correspond, generates first information of a spatial layer with an index 2 by using an AI/ML model to which 100 bits correspond, generates first information of a spatial layer with an index 3 by using an AI/ML model to which 80 bits correspond, generates first information of a spatial layer with an index 4 by using an AI/ML model to which 70 bits correspond, generates first information of a spatial layer with an index 5 by using an AI/ML model to which 70 bits correspond, and generates first information of a spatial layer with an index 6 by using an AI/ML model to which 60 bits correspond.

TABLE 6

| | Bitwidth and/or a |
|---|---|
| Index of a | maximum value of the bitwidth |
| spatial layer | of the first information |
| 1 | 120 bits |
| 2 | 100 bits |
| 3 | 80 bits |
| 4 | 70 bits |
| 5 | 70 bits |
| 6 | 60 bits |

For a further example, the network device configures information shown in Table 7 below, a value to which the third information corresponds is 5, and a value to which the RI obtained by the terminal equipment corresponds is 3, then the terminal equipment generates first information of a spatial layer with an index 1 by using an AI/ML model to which 100 bits correspond, generates first information of a spatial layer with an index 2 by using an AI/ML model to which 100 bits correspond, and generates first information of a spatial layer with an index 3 by using an AI/ML model to which 100 bits correspond. In this example, the three AI/ML models are identical.

TABLE 7

| Index of a | Bitwidth and/or a maximum value of the |
|---|---|
| spatial layer | bitwidth of the first information |
| 1 | 100 bits |
| 2 | 100 bits |
| 3 | 100 bits |
| 4 | 100 bits |
| 5 | 100 bits |

In embodiment 3, reference may be made to relevant technologies for a format of the CSI report transmitted by the terminal equipment via an uplink channel.

### Embodiment 4

In embodiment 4, for a spatial layer configured with at least two types of bitwidth information and/or model information, the terminal equipment transmits first indication information to the network device, the first indication information being used to indicate bitwidth information and/or model information on which the terminal equipment is based in determining the model.

Following description shall be given by taking the case where the first configuration includes bitwidth information (such as a bitwidth and/or a maximum value of the bitwidth) as an example.

In some implementations, the network device configures at least two types of bitwidths of the first information. The configuration is included in the CSI report configuration. The network device configures at least one bitwidth and/or a maximum value of the bitwidths of the first information for each spatial layer. The number of the spatial layers is equal to a value to which the third information corresponds.

In some implementations, the network device configures at least one bitwidth and/or a maximum value of the bitwidths of the first information for each spatial layer, at least two spatial layers are configured with at least two bitwidths and/or a maximum value of the bitwidths of the first information. There may be at least two spatial layers, and there may be or may not be a common bitwidth and/or a maximum value of the bitwidth of the first information.

For example, the network device configures information shown in Table 8 below, a value to which the third information corresponds is 3, a value to which the RI obtained by the terminal equipment corresponds is 2, then the terminal equipment generates first information of a spatial layer with an index 1 by using an AI/ML model to which 120 bits correspond, generates first information of a spatial layer with an index 2 by using an AI/ML model to which 80 bits correspond. The terminal equipment may possibly generate first information of a spatial layer with an index 1 by using an AI/ML model to which 100 bits correspond, and generate first information of a spatial layer with an index 2 by using an AI/ML model to which 120 bits correspond. And the terminal equipment may possibly generate first information of a spatial layer with an index 1 by using an AI/ML model to which 80 bits correspond, and generate first information of a spatial layer with an index 2 by using an AI/ML model to which 80 bits correspond.

TABLE 8

| Index of a | Bitwidth and/or a maximum value of |
|---|---|
| spatial layer | the bitwidth of the first information |
| 1 | 120 bits, 100 bits, 80 bits, 70 bits |
| 2 | 120 bits, 80 bits |
| 3 | 60 bits |

As a bitwidth and/or a maximum value of the bitwidth of the first information of each spatial layer is/are configured by the network device, the network device learns which spatial layers have bitwidths and/or maximum values of the bitwidths of at least two types of selectable first information, and learns the number of bitwidths that each layer may select. For bitwidths and/or maximum values of the bitwidths of at least two types of selectable first information, these values may be mapped into indices, as shown in Table 9 below.

TABLE 9

| Index of | Index | Bit description | A bitwidth and/or a maximum |
|---|---|---|---|
| a spatial | of a | of an index of | value of the bitwidth |
| layer | bitwidth | a bitwidth | of the first information |
| 1 | 1 | 00 | 120 bits |
| | 2 | 01 | 100 bits |
| | 3 | 10 | 80 bits |
| | 4 | 11 | 70 bits |
| 2 | 1 | 0 | 120 bits |
| | 2 | 1 | 80 bits |
| 3 | N/A | N/A | 60 bits |

Where, N/A denotes not applicable. The indices of the bitwidths may be formulated according to a certain rule, such as those specified in the standards, or may be agreed upon by the network device and the terminal equipment. In this example, the indices are arranged in an order of the bitwidths from large to small.

The CSI report transmitted by the terminal equipment via the uplink channel may include an index of a bitwidth used by the terminal equipment in reporting for the spatial layer configured with bitwidths and/or maximum values of the bitwidths of at least two types of the first information. These types of information may be included in a first part of the CSI (part 1 CSI). For example, a value to which the RI obtained by the terminal equipment corresponds is 2, and the terminal equipment generates first information of a spatial layer with an index 1 by using an AI/ML model to which 120 bits correspond, and generates first information of a spatial layer with an index 2 by an AI/ML model to which 80 bits correspond. Hence, in part 1 of the CSI report, a bit description of the index of the bitwidth of the spatial layer with an index 1 is also reported, which is 10, and a bit description of the index of the bitwidth of the spatial layer with an index 2 is also reported, which is 1.

In addition, reference may be made to related art for explanations of the first part of the CSI (part 1 CSI).

### Embodiment 5

In embodiment 5, for a value of the rank indicator, the precoding matrix information is configured with at least one type of bitwidth information and/or model information.

Following description shall be given by taking the case where the first configuration includes bitwidth information (such as a bitwidth and/or a maximum value of the bitwidth) as an example.

In some implementations, the network device configures at least two types of bitwidths of the first information. The configuration is included in the CSI report configuration. The network device configures bitwidths and/or maximum values of the bitwidths of at least one type of the first information for each possible rank indicator (RI) in the CSI report. A value to which the RI corresponds is a positive integer less than or equal to a value to which the third information corresponds. These bitwidths and/or maximum values of the bitwidths may be identical, or at least two of them are different.

In some implementations, the network device configures a bitwidth and/or a maximum value of the bitwidth of the first information for a value to which each possible RI corresponds in the CSI report. For the value to which each possible RI corresponds, the terminal equipment generates CSI by using a corresponding AI/ML model according to the configuration. Specifically, bitwidths and/or maximum values of the bitwidths of the first information of the spatial layers are identical. In other words, the terminal equipment generates CSI by using identical AI/ML models for the spatial layers.

For example, the network device configures information shown in Table 10 below, and a value to which the RI obtained by the terminal equipment corresponds is 2, then the terminal equipment generates first information of a spatial layer with an index 1 by using an AI/ML model to which 110 bits correspond, and generates first information of a spatial layer with an index 2 by using an AI/ML model to which 110 bits correspond.

TABLE 10

| Value to which | A bitwidth and/or a maximum |
|---|---|
| the RI | value of the bitwidth of |
| corresponds | the first information |
| 1 | 120 bits |
| 2 | 110 bits |
| 3 | 90 bits |
| 4 | 80 bits |

As the bitwidth and/or the maximum value of the bitwidth of the first information corresponding to the value to which each RI corresponds is configured by the network device, the network device may learn the bitwidth and/or the maximum value of the bitwidth of the first information of each spatial layer after learning the RI. At this time, a format specified in related art may be used as the format of the CSI report transmitted by the terminal equipment via the uplink channel.

### Embodiment 6

In embodiment 6, for the value configured with at least two types of bitwidth information and/or model information, the terminal equipment transmits second indication information to the network device, the second indication information being used to indicate the bitwidth information and/or model information on which the terminal equipment is based in determining the model.

Following description shall be given by taking the case where the first configuration includes bitwidth information (such as a bitwidth and/or a maximum value of the bitwidth) as an example.

In some implementations, the network device configures at least two types of bitwidths of the first information. The configuration is included in the CSI report configuration. The network device configures bitwidths and/or maximum values of the bitwidths of at least one type of the first information for a value to which each possible RI corresponds in the CSI report. The value to which the RI corresponds is a positive integer less than or equal to a value to which the third information corresponds. These bitwidths and/or maximum values of the bitwidths may be identical, or at least two of them are different.

In some implementations, the network device configures at least two bitwidths and/or maximum values of the bitwidths for a value to which at least one possible RI corresponds. For a value to which each possible RI corresponds, the terminal equipment generates CSI by using a corresponding AI/ML model according to the configuration. Specifically, bitwidths and/or maximum values of the bitwidths of the first information of the spatial layers are identical. In other words, the terminal equipment generates CSI by using identical AI/ML models for the spatial layers.

For example, the network device configures information shown in Table 11 below, the value to which the third information corresponds is 4, and as the bitwidth and/or the maximum value of the bitwidth of the first information corresponding to the value to which each RI corresponds is configured by the network device, the network device learns which values corresponding to the RI have bitwidths and/or maximum values of the bitwidths of at least two pieces selectable first information, and learns how many bitwidths therein are available. Therefore, the network device learns maximum numbers of bitwidths and/or maximum values of the bitwidths of the selectable first information of values to which all RIs correspond. The maximum numbers are referred to as tenth information.

TABLE 11

| | Indices of a bitwidth and/ | | The bitwidth and/or |
|---|---|---|---|
| Value to | or a maximum value of | Bit description | the maximum value |
| which an RI | the bitwidth of the first | of an index of | of the bitwidth of the |
| corresponds | information | a bitwidth | first information |
| 1 | N/A | N/A | 120 bits |
| 2 | 1 | 0 | 110 bits |
| | 2 | 1 | 100 bits |
| 3 | N/A | N/A | 90 bits |
| 4 | N/A | N/A | 80 bits |

As the network device is uncertain about the value of the RI obtained by the terminal equipment, the CSI report needs to include information (e.g. referred to as eleventh information) on the bitwidth and/or the maximum value of the bitwidth of the first information. The eleventh information, such as an index, may be described by using a bit string. In this example, the tenth information is 2, therefore, the eleventh information may be represented as Table 12 below, which may be specified in the standards, or may be agreed upon between the terminal equipment and the network device. The index of the bitwidth may be formulated according to a certain rule, such as those specified in the standards, or may be agreed upon by the network device and the terminal equipment. In this example, the indices are arranged in an order of the bitwidths from large to small.

TABLE 12

| Indices of a bitwidth and/or a | Bit description of |
|---|---|
| maximum value of the bitwidth | the eleventh |
| of the first information | information |
| N/A | 00 |
| 0 | 10 |
| 1 | 11 |

The eleventh information may be included in a first part of the CSI (part 1 CSI). For example, a value to which the RI obtained by the terminal equipment corresponds is 2, the terminal equipment generates first information of a spatial layer with an index 1 by using an AI/ML mode to which 110 bits correspond, and generates first information of a spatial layer with an index 2 by using an AI/ML mode to which 110 bits correspond (identical AI/ML models). In part 1 of the CSI report, bit representation of the eleventh information, i.e. 10, is also reported. For another example, a value to which the RI obtained by the terminal equipment corresponds is 3, the terminal equipment generates first information of a spatial layer with an index 1 by using an AI/ML mode to which 90 bits correspond, generates first information of a spatial layer with an index 2 by using an AI/ML mode to which 90 bits correspond, and generates first information of a spatial layer with an index 3 by using an AI/ML mode to which 90 bits correspond (identical AI/ML models). Hence, in part 1 of the CSI report, bit representation of the eleventh information, i.e. 00, is also reported.

### Embodiment 7

In embodiment 7, at least one spatial layer under at least one value of the rank indicator is configured with at least one type of bitwidth information or model information.

Following description shall be given by taking the case where the first configuration includes bitwidth information (such as a bitwidth and/or a maximum value of the bitwidth) as an example.

In some implementations, the network device configures at least two types of bitwidths of the first information. The configuration is included in the CSI report configuration. The network device configures bitwidths and/or maximum values of the bitwidths of at least one type of the first information for spatial layer under a value to which each possible RI corresponds in the CSI report. The value to which the RI corresponds is a positive integer less than or equal to a value to which the third information corresponds. These bitwidths and/or maximum values of the bitwidths may be identical, or at least two of them are different.

Following example is based on embodiment 5. For a value to which an RI greater than 1 corresponds, the network device further configures a bitwidth and/or a maximum value of the bitwidth of the first information for each spatial layer. For example, the network device configures information shown in Table 13 below, wherein the value to which the third information corresponds is 3.

TABLE 13

| | | Bitwidth and/or a | Bitwidth and/or a |
|---|---|---|---|
| | Bitwidth and/or a | maximum value of | maximum value of |
| | maximum value of the | the bitwidth of the | the bitwidth of the |
| | bitwidth of the first | first information of | first information of |
| Value | information of a spatial | a spatial layer with | a spatial layer with |
| to which an RI corresponds | layer with an index 1 (bits) | an index 2 (bits) | an index 3 (bits) |
| 1 | 120 | N/A | N/A |
| 2 | 100 | 100 | N/A |
| 3 | 110 | 80 | 70 |

A format specified in related art may be used as the format of the CSI report transmitted by the terminal equipment via the uplink channel.

### Embodiment 8

In embodiment 8, the terminal equipment transmits third indication information to the network device, the third indication information being used to indicate bitwidth information and/or model information to which the model determined separately by the terminal equipment for each spatial layer corresponds.

Following description shall be given by taking the case where the first configuration includes bitwidth information (such as a bitwidth and/or a maximum value of the bitwidth) as an example.

In some implementations, the network device configures at least two types of bitwidths of the first information. The configuration is independent of a spatial layer and an RI. For example, the network device configures information shown in Table 14 below, and a value to which the third information corresponds is 4. At least two types of bitwidths and/or maximum values of the bitwidths of the first information are as shown in Table 14.

TABLE 14

| | Bit | Bitwidth and/or a maximum |
|---|---|---|
| | representations | value of the bitwidth of |
| Indices | of indices | the first information (bits) |
| 0 | 000 | 0 |
| 1 | 001 | 130 |
| 2 | 010 | 112 |
| 3 | 011 | 100 |
| 4 | 100 | 75 |
| 5 | 101 | 60 |

Where, index 0 indicates that the terminal equipment does not report the first information in the spatial layer. The terminal equipment selects the bitwidth and/or the maximum value of the bitwidth of the first information for each spatial layer according to the RI it obtains, that is, a corresponding AI/ML model is selected.

For example, a value to which the RI obtained by the terminal equipment corresponds is 2. The terminal equipment generates the first information by using the AI/ML model to which the bitwidth of the first information with an index 2 corresponds for the spatial layer with an index 1, and the terminal equipment generates the first information by using the AI/ML model to which the bitwidth of the first information with an index 4 corresponds for the spatial layer with an index 2.

In the CSI report, as the network device does not learn the RI value obtained by the terminal equipment (before receiving the CSI report), the terminal equipment needs to report information on bitwidths of first information of Y spatial layers, such as indices; where, Y is equal to the value to which the third information corresponds.

In this example, the value to which the third information corresponds is 4, that is, Y=4. The terminal equipment may report the RI and indices of the bitwidths of the Y pieces of the first information in part 1 of the CSI. The terminal equipment reports the first information in part 2 of the CSI. For example, a value to which the RI obtained by the terminal equipment corresponds is 2, the terminal equipment reports the RI and information on the bitwidths of the four pieces of the first information, which is 010100000000, in part 1 of the CSI, wherein in this information, meanings of bits from left to right are that 010 denotes an index of the bitwidth of the first information of the spatial layer with an index 1, 100 denotes an index of the bitwidth of the first information of the spatial layer with an index 2, 000 denotes an index of the bitwidth of the first information of the spatial layer with an index 3, and 000 denotes an index of the bitwidth of the first information of the spatial layer with an index 4.

### Embodiment 9

In the embodiments of this disclosure, as the terminal equipment and the network device have completed pairing of the AI/ML models, after the pairing of the AI/ML models, a bitwidth and/or a maximum value of the bitwidth of a piece of first information correspond(s) only to one AI/ML model pair (e.g. one AI/ML model pair includes a first AI/ML model and a second AI/ML model paired with each other).

In embodiment 9, the configuration of “the bitwidth and/or the maximum value of the bitwidth” in embodiments 1-8 (e.g. tables 1-14) may be replaced with a configuration of the AI/ML model information.

After pairing of the AI/ML models, the paired AI/ML models may be assigned first identifiers, such as IDs or indices. Arrangement of the first identifiers may be those specified in the standards, or may be agreed upon between the terminal equipment and the network device. For a case where an AI/ML model supports only a bitwidth of one piece of the first information, one first identifier may be assigned to the AI/ML model, and for a case where an AI/ML model supports bitwidths of Z (Z>1, and Z is a natural number) pieces of the first information, N first identifiers may be assigned to the AI/ML model, each first identifier corresponding to a bitwidth of one piece of the first information. As the bitwidth and/or the maximum value of the bitwidth of the first information correspond(s) only to one AI/ML model pair, the first identifier is in a one-to-one correspondence with the bitwidth of the first information.

In some implementations, it is assumed that after the pairing of the AI/ML models, the network device and the terminal equipment jointly support three models, each of which having unique information describing it, such as information in network devices and terminal equipments manufactured by all manufacturers that is able to uniquely identify it, such as a global identifier. A bitwidth of first information of a first one of the models is 140 bits, and a global identifier thereof is doengjf0t3, a bitwidth of first information of a second one of the models is 70 bits, and a global identifier thereof is swirnvv024jos, and a third one of the models supports bitwidths of three pieces of the first information, a global identifier thereof is 43dnfogba0cndi, and the bitwidths of the first information it supports are 120 bits, 105 bits, and 60 bits, respectively. The first identifiers are assigned in a descending order of the supported bitwidths of the first information from large to small, as shown in Table 15.

TABLE 15

| First identifier | Global identifier |
|---|---|
| Model A | doengjf0t3 |
| Model B | 43dnfogbaOcndi (120 bits) |
| Model C | 43dnfogba0cndi (105 bits) |
| Model D | swirnvv024jos |
| Model E | 43dnfogba0cndi (60 bits) |

When the network device configures and/or the terminal equipment reports the AI/ML model information, the first identifier is used.

### Embodiment 10

In embodiment 10, the terminal equipment receives fourth configuration from the network device, the fourth configuration being used to configure that,
the models used in each spatial layers are identical, or the models used in at least two spatial layers are different; and/or
for at least two values of rank indicator, the models used for generating the precoding matrix information corresponding to each value are identical, or the models used for generating the precoding matrix information corresponding to the at least two values are different.

In at least one implementation, at least a part of the first configuration is the fourth configuration, or the first configuration does not include the fourth configuration.

In at least one implementation, the models configured to be used at the spatial layers are identical, and the terminal equipment transmits fourth indication information to the network device, the fourth indication information being used to indicate information on the determined model.

In at least one implementation, the models configured to be used for at least two spatial layers are different, and the terminal equipment transmits fifth indication information to the network device, the fifth indication information being used to indicate information on models determined respectively at the spatial layers.

In at least one embodiment, a first value to which the rank indicator corresponds is less than the value to which the third information corresponds, and the fifth indication information may include N pieces of the fourth information; where, N is a difference obtained by subtracting the first value from the value to which the third information corresponds, wherein the fourth information indicates absence of the model. In addition, the fourth information is predefined information.

For example, the value to which the third information corresponds is configured to be 4, and the first value to which the rank indicator reported by the terminal equipment corresponds should not exceed 4. Assuming that the first value to which the rank indicator reported by the terminal equipment corresponds is 3, it indicates that the terminal equipment reports information on a model to which layer 2 transmission corresponds, such as A, B and A. However, as the network device does not learn the first value before the terminal equipment reports, the terminal equipment needs to report four pieces of model information, such as A, B, A, and empty, wherein the ‘empty’ is the fourth information.

Embodiment 10 shall be illustrated below.

In some implementations, the terminal equipment gives at least one piece of the following information via the fourth configuration that: the AI/ML models used by the spatial layers are identical or different; and all possibilities of values to which at least one RI correspond use identical or different AI/ML models. A beneficial effect of this implementation is that the network device directly and clearly configures a method for using AI/ML models in the spatial layers and/or within a range of the value to which the RI corresponds, which is simple and easy to understand. And at the same time, there are no restrictions on a specific used model, leaving the terminal equipment with opportunities to choose a most suitable model, which may improve system performance, such as system throughput.

The fourth configuration further includes information on at least one AI/ML model configured by the network device. The fourth configuration may be a CSI report configuration, for example, the fourth configuration is included in the first configuration.

For example, information in the above fourth configuration may be mapped into indices, as shown in Table 16 and Table 17 below.

TABLE 16

| First index | Use of AI/ML models in a spatial layer dimension |
|---|---|
| 0 | AI/ML models used by all spatial layers are identical |
| 1 | AI/ML models used by at least two spatial layers are |
| | different |

TABLE 17

| Second index | Use of AI/ML models in an RI dimension |
|---|---|
| 0 | AI/ML models used by all possible RIs are identical |
| 1 | AI/ML models used by at least two possible RIs are different |

In the fourth configuration, an order of the first index and the second index may be specified in the standards, or may be agreed upon by the terminal equipment and the network device. In this example, it is assumed that the first index is before the second index. In the fourth configuration, information on available AI/ML models (i.e. information on paired AI/ML models) is further given, such as Table 15 above.

In some implementations, the first index and the second index given by the network device in the fourth configuration are 00, AI/ML models used by all the spatial layers are identical, and AI/ML models used by all the possible RIs are identical. In this case, the terminal equipment needs only to report information on one AI/ML model, for example, it may report an identifier and/or an index of the AI/ML model, such as the first identifier, in part 1 of the CSI report.

In some implementations, the first index and the second index given by the network device in the fourth configuration are 01, AI/ML models used by all the spatial layers are identical, and AI/ML models used by at least two possible RIs are different. In this case, the format of the CSI report of the terminal equipment may be identical to that in the case where the first index and the second index are 00.

In some implementations, the first index and the second index given by the network device in the fourth configuration are 10, AI/ML models used by at least two spatial layers are different, and AI/ML models used by all the possible RIs are identical. In this case, the number of pieces of information on an AI/ML model that the terminal equipment needs to report is the value to which the third information corresponds. If the value to which the RI corresponds is less than the value to which the third information corresponds, after AI/ML model identifiers of a number that is the value to which the RI corresponds are reported, thirtieth information of a number that is a difference between the value to which the third information corresponds and the value to which the RI corresponds is reported, the thirtieth information indicating absence of AI/ML models. For example, the identifier and/or the index of the AI/ML model may be reported in part 1 of the CSI report, such as the second representation and/or the thirtieth information. For example, the value to which the third information corresponds is 3, the value to which the RI corresponds is 2, and the terminal equipment needs to report two second identifiers and one piece of the thirtieth information.

In some implementations, the first index and the second index given by the network device in the fourth configuration are 11, AI/ML models used by at least two spatial layers are different, and AI/ML models used by at least two possible RIs are different. In this case, the format of the CSI report of the terminal equipment may be identical to that in the case where the first index and the second index are 10.

The embodiment of the first aspect of this disclosure are described above with reference to embodiments 1-10. The above embodiments 1-10 are not intended to limit implementation of the technical solution of this disclosure. For example, the above embodiments 1-10 may be reasonably combined or modified.

The embodiment of the first aspect of this disclosure provides the configurations and the format of the CSI report needed in generating and transmitting the CSI based on the AI/ML method. This disclosure provides corresponding configurations and reporting formats for at least one possible scenario. This disclosure provides a format of the CSI report applicable to at least a part of the configurations, which may achieve an effect that the network device understands the CSI without ambiguity. This disclosure provides a reporting format that is able to reduce contents of the CSI report for a part of the configurations. Hence, overhead of reporting the CSI may be lowered, and this reporting format may also enable the network device to understand the CSI without ambiguity.

### Embodiment of a Second Aspect

The embodiment of the second aspect provides a channel state information configuration method, applicable to a network device, such as the network device 201 in FIG. 2. For parts in the embodiment of the second aspect that are identical to those in the embodiment of the first aspect, reference may be made to the explanations in the embodiment of the first aspect, which shall not be repeated herein any further.

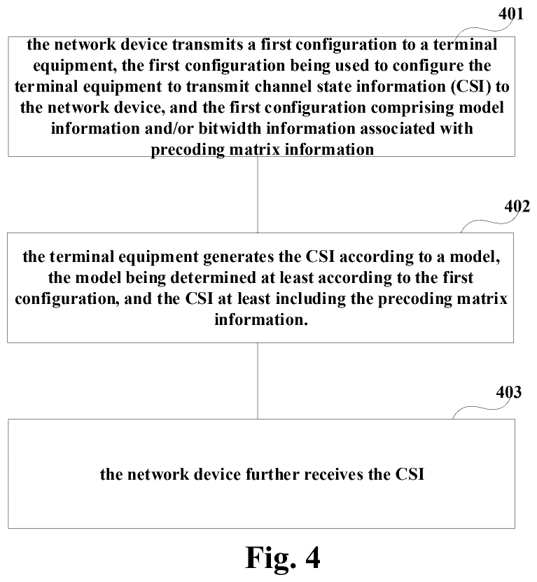

FIG. 4 is a schematic diagram of the channel state information configuration method of the embodiment of the second aspect. The method includes:
operation 401: the network device transmits a first configuration to a terminal equipment, the first configuration being used to configure the terminal equipment to transmit channel state information (CSI) to the network device, and the first configuration comprising model information and/or bitwidth information associated with precoding matrix information; and
operation 402: the terminal equipment generates the CSI according to a model, the model being determined at least according to the first configuration, and the CSI at least including the precoding matrix information.

In some embodiments, as shown in FIG. 4, the method further includes:
operation 403: the network device further receives the CSI.

In some embodiments, the first configuration includes a CSI report configuration and/or a physical uplink control channel configuration and/or a physical uplink shared channel configuration.

In some embodiments, the model is an artificial intelligence model.

In some embodiments, the model is set by the first configuration, and/or the model is determined by the terminal equipment according to the first configuration.

In some embodiments, the precoding matrix information is associated with spatial layer information.

In some embodiments, bitwidth information related to the precoding matrix information includes:
a bitwidth of the precoding matrix information, and/or an index of the bitwidth of the precoding matrix information, and/or a maximum value of the bitwidth of the precoding matrix information, and/or an index of the maximum value of the bitwidth of the precoding matrix information.

In some embodiments, the first configuration further instructs the terminal equipment to report a rank indicator, and the CSI further includes the rank indicator.

In some embodiments, the network device further transmits a second configuration to the terminal equipment, the second configuration including third information and/or antenna port information, the third information being used to restrict the rank indicator in the CSI and/or a value to which the rank indicator corresponds.

In some embodiments, at least a part of the first configuration is the second configuration, or the first configuration does not include the second configuration.

In some embodiments, the network device further transmits a third configuration to the terminal equipment, the third configuration including third information, the third configuration including a configuration for generating the precoding matrix information and/or the CSI,
and the third information being used to restrict the rank indicator in the CSI and/or a value to which the rank indicator corresponds.

In some embodiments, the third configuration is included in the second configuration, or the third configuration is not included in the second configuration.

In some embodiments, the first configuration includes at least two types of the bitwidth information and/or the model information.

In some embodiments, the first configuration includes at least two types of the bitwidth information and/or the model information.

In some embodiments, the precoding matrix information of at least one spatial layer is configured with at least one type of the bitwidth information and/or the model information.

In some embodiments, for the spatial layer configured with at least two types of the bitwidth information and/or the model information, the network device receives first indication information transmitted by the terminal equipment, the first indication information being used to indicate bitwidth information and/or model information on which the terminal equipment is based in determining the model.

In some embodiments, for a value of the rank indicator, the precoding matrix information is configured with at least one type of the bitwidth information and/or model information.

In some embodiments, for the values configured with at least two types of bitwidth information or model information, the network device receives second indication information transmitted by the terminal equipment, the second indication information being used to indicate the bitwidth information and/or model information on which the terminal equipment is based in determining the model.

In some embodiments, at least one spatial layer under at least one value of the rank indicator is configured with at least one type of bitwidth information and/or model information.

In some embodiments, the network device receives third indication information transmitted by the terminal equipment, the third indication information being used to indicate the bitwidth information and/or the model information to which the model determined separately by the terminal equipment for each spatial layer corresponds.

In some embodiments, the network device transmits a fourth configuration to the terminal equipment, the fourth configuration being used to configure that,
the models used in each spatial layers are identical, or the models used in at least two spatial layers are different; and/or
for at least two values of the rank indicator, the models used for generating the precoding matrix information corresponding to each value are identical, or the models used for generating the precoding matrix information corresponding to the at least two values are different.

In some embodiments, at least a part of the first configuration is the fourth configuration, or the first configuration does not include the fourth configuration.

In some embodiments, models configured to be used in the spatial layers are identical, and the network device receives fourth indication information transmitted by the terminal equipment, the fourth indication information being used to indicate the information on the determined model.

In some embodiments, models configured to be used in at least two spatial layers are different,
and the network device receives fifth indication information transmitted by the terminal equipment, the fifth indication information being used to indicate information on models determined respectively at the spatial layers.

In some embodiments, a first value to which the rank indicator corresponds is less than the value to which the third information corresponds, and the fifth indication information includes N pieces of the fourth information; where, N is a difference obtained by subtracting the first value from the value to which the third information corresponds

In some embodiments, the fourth information is predefined information.

In some embodiments, the fourth information indicates absence of the model.

### Embodiment of a Third Aspect

Addressed to the same problem as the embodiment of the first aspect, the embodiment of the third aspect provides a channel state information generation apparatus, applicable to a terminal equipment. This apparatus corresponds to the method in the embodiment of the first aspect.

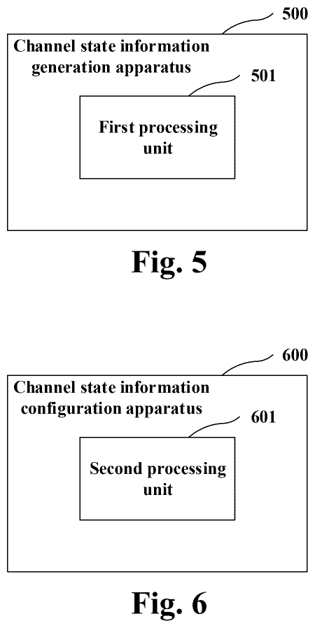

FIG. 5 is a schematic diagram of the channel state information generation apparatus of the embodiment of the third aspect. As shown in FIG. 5, the channel state information generation apparatus 500 includes a first processing unit 501.

The first processing unit 501 causes the terminal equipment to execute the following operations:
receiving a first configuration by the terminal equipment from a network device, the first configuration being used to configure the terminal equipment to transmit channel state information (CSI) to the network device, and the first configuration comprising model information and/or bitwidth information associated with precoding matrix information; and
generating the CSI by the terminal equipment according to a model, the model being determined at least according to the first configuration, and the CSI at least including the precoding matrix information.

In some embodiments, the operations further include:
transmitting the CSI by the terminal equipment to the network device.

In some embodiments, the first configuration includes a CSI report configuration and/or a physical uplink control channel configuration and/or a physical uplink shared channel configuration.

In some embodiments, the model is an artificial intelligence model.

In some embodiments, the model is set by the first configuration, and/or the model is determined by the terminal equipment according to the first configuration.

In some embodiments, the precoding matrix information is associated with spatial layer information.

In some embodiments, bitwidth information related to the precoding matrix information includes:
a bitwidth of the precoding matrix information, and/or an index of the bitwidth of the precoding matrix information, and/or a maximum value of the bitwidth of the precoding matrix information, and/or an index of the maximum value of the bitwidth of the precoding matrix information.

In some embodiments, the first configuration further instructs the terminal equipment to report a rank indicator, and the CSI further includes the rank indicator.

In some embodiments, the terminal equipment further receives a second configuration transmitted by the network device,
the second configuration including third information and/or antenna port information, the third information being used to restrict the rank indicator in the CSI and/or a value to which the rank indicator corresponds.

In some embodiments, at least a part of the first configuration is the second configuration, or the first configuration does not include the second configuration.

In some embodiments, the terminal equipment further receives a third configuration transmitted by the network device, the third configuration including the third information, the third configuration including a configuration used for generating the precoding matrix information and/or the CSI, and the third information being used to restrict the rank indicator in the CSI and/or a value to which the rank indicator corresponds.

In some embodiments, the third configuration is included in the second configuration, or the third configuration is not included in the second configuration.

In some embodiments, the first configuration includes at least one type of bitwidth information and/or model information.

In some embodiments, the first configuration includes at least two types of the bitwidth information and/or the model information.

In some embodiments, the precoding matrix information of at least one spatial layer is configured with at least one type of the bitwidth information and/or the model information.

In some embodiments, for the spatial layer configured with at least two types of the bitwidth information and/or the model information, the terminal equipment transmits first indication information to the network device, the first indication information being used to indicate bitwidth information and/or model information on which the terminal equipment is based in determining the model.

In some embodiments, for a value of the rank indicator, the precoding matrix information is configured with at least one type of the bitwidth information and/or the model information.

In some embodiments, for the value configured with at least two types of bitwidth information and/or model information, the terminal equipment transmits second indication information to the network device, the second indication information being used to indicate the bitwidth information and/or model information on which the terminal equipment is based in determining the model.

In some embodiments, at least one spatial layer under at least one value of the rank indicator is configured with at least one type of bitwidth information or model information.

In some embodiments, the terminal equipment transmits third indication information to the network device, the third indication information being used to indicate the bitwidth information and/or the model information to which the model determined separately by the terminal equipment for each spatial layer corresponds.

In some embodiments, the terminal equipment receives a fourth configuration from the network device, the fourth configuration being used to configure that,
the models used in each the spatial layers are identical, or the models used in at least two spatial layers are different; and/or
for at least two values of the rank indicator, the models used for generating the precoding matrix information corresponding to each value are identical, or the models used for generating the precoding matrix information corresponding to at least two values are different.

In some embodiments, at least a part of the first configuration is the fourth configuration, or the first configuration does not include the fourth configuration.

In some embodiments, the models configured to be used at the spatial layers are identical, and the terminal equipment transmits fourth indication information to the network device, the fourth indication information being used to indicate information on the determined model.

In some embodiments, the models configured to be used for at least two spatial layers are different, and the terminal equipment transmits fifth indication information to the network device, the fifth indication information being used to indicate information on models determined respectively at the spatial layers.

In some embodiments, a first value to which the rank indicator corresponds is less than the value to which the third information corresponds, and the fifth indication information may include N pieces of the fourth information; where, N is a difference obtained by subtracting the first value from the value to which the third information corresponds.

In some embodiments, the fourth information is predefined information.

In some embodiments, the fourth information indicates absence of the model.

### Embodiment of a Fourth Aspect

The embodiment of the fourth aspect provides a channel state information configuration apparatus, applicable to a network device. This apparatus corresponds to the method in the embodiment of the second aspect.

FIG. 6 is a schematic diagram of the channel state information configuration apparatus of the embodiment of the fourth aspect. As shown in FIG. 6, the apparatus 600 includes: a second processing unit 601.

In at least one embodiment, the second processing unit 601 controls the network device to execute the following operations:
transmitting a first configuration by the network device to a terminal equipment, the first configuration being used to configure the terminal equipment to transmit channel state information (CSI) to the network device, and the first configuration comprising model information and/or bitwidth information associated with precoding matrix information.

The CSI is generated by the terminal equipment according to a model, the model being determined at least according to the first configuration, and the CSI at least comprising the precoding matrix information.

In some embodiments, the network device further receives the CSI.

In some embodiments, the first configuration includes a CSI report configuration and/or a physical uplink control channel configuration and/or a physical uplink shared channel configuration.

In some embodiments, the model is an artificial intelligence model.

In some embodiments, the model is set by the first configuration, and/or the model is determined by the terminal equipment according to the first configuration.

In some embodiments, the precoding matrix information is associated with spatial layer information.

In some embodiments, bitwidth information related to the precoding matrix information includes:
a bitwidth of the precoding matrix information, and/or an index of the bitwidth of the precoding matrix information, and/or a maximum value of the bitwidth of the precoding matrix information, and/or an index of the maximum value of the bitwidth of the precoding matrix information.

In some embodiments, the first configuration further instructs the terminal equipment to report a rank indicator, and the CSI further includes the rank indicator.

In some embodiments, the network device further transmits a second configuration to the terminal equipment, the second configuration including third information and/or antenna port information, the third information being used to restrict the rank indicator in the CSI and/or a value to which the rank indicator corresponds.

In some embodiments, at least a part of the first configuration is the second configuration, or the first configuration does not include the second configuration.

In some embodiments, the network device further transmits a third configuration to the terminal equipment, the third configuration including the third information, the third configuration including a configuration used for generating the precoding matrix information and/or the CSI, and the third information being used to restrict the rank indicator in the CSI and/or a value to which the rank indicator corresponds.

In some embodiments, the third configuration is included in the second configuration, or the third configuration is not included in the second configuration.

In some embodiments, the first configuration includes at least one type of bitwidth information and/or model information.

In some embodiments, the first configuration includes at least two types of the bitwidth information and/or the model information.

In some embodiments, the precoding matrix information of at least one spatial layer is configured with at least one type of the bitwidth information and/or the model information.

In some embodiments, for the spatial layer configured with at least two types of the bitwidth information and/or the model information, the network device receives first indication information transmitted by the terminal equipment, the first indication information being used to indicate bitwidth information and/or model information on which the terminal equipment is based in determining the model.

In some embodiments, for a value of the rank indicator, the precoding matrix information is configured with at least one type of the bitwidth information and/or the model information.

In some embodiments, for the value configured with at least two types of bitwidth information and/or model information, the network device receives second indication information transmitted by the terminal equipment, the second indication information being used to indicate the bitwidth information and/or model information on which the terminal equipment is based in determining the model.

In some embodiments, at least one spatial layer under at least one value of the rank indicator is configured with at least one type of bitwidth information or model information.

In some embodiments, the network device receives third indication information transmitted by the terminal equipment, the third indication information being used to indicate the bitwidth information and/or the model information to which the model determined separately by the terminal equipment for each spatial layers corresponds.

In some embodiments, the network device transmits a fourth configuration to the terminal equipment, the fourth configuration being used to configure that,
the models used in each spatial layers are identical, or the models used in at least two spatial layers are different; and/or
for at least two values of the rank indicator, the models used for generating the precoding matrix information corresponding to each value are identical, or the models used for generating the precoding matrix information corresponding to the at least two values are different.

In some embodiments, at least a part of the first configuration is the fourth configuration, or the first configuration does not include the fourth configuration.

In some embodiments, the models configured to be used at the spatial layers are identical,
and the network device receives fourth indication information transmitted by the terminal equipment, the fourth indication information being used to indicate information on the determined model.

In some embodiments, the models configured to be used for at least two spatial layers are different,
and the network device receives fifth indication information transmitted by the terminal equipment, the fifth indication information being used to indicate information on models determined respectively at the spatial layers.

In some embodiments, a first value to which the rank indicator corresponds is less than the value to which the third information corresponds, and the fifth indication information includes N pieces of the fourth information; where, N is a difference obtained by subtracting the first value from the value to which the third information corresponds.

In some embodiments, the fourth information is predefined information.

In some embodiments, the fourth information indicates absence of the model.

### Embodiment of a Fifth Aspect

The embodiment of the fifth aspect of this disclosure provides a communication system, including a network device and a terminal equipment.

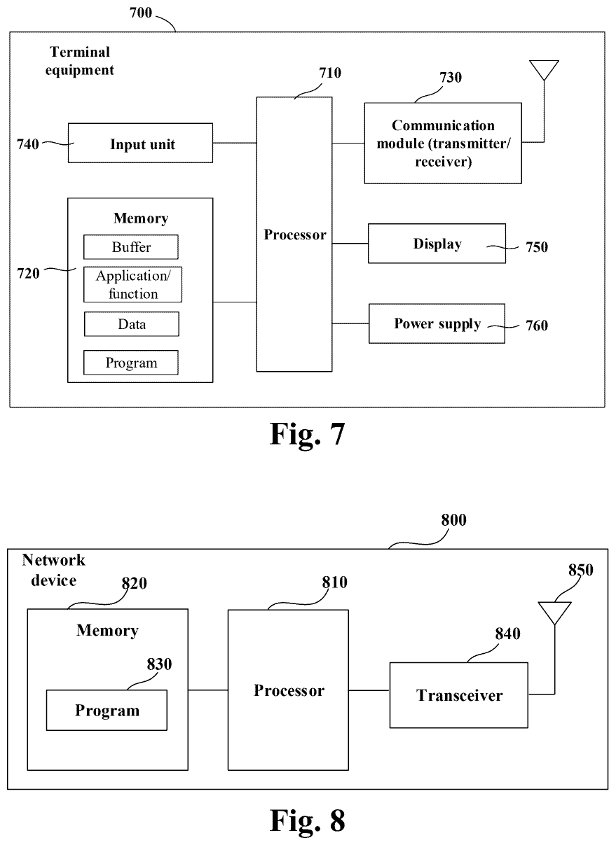

FIG. 7 is a schematic diagram of the terminal equipment of the embodiment of the fifth aspect. As shown in FIG. 7, the terminal equipment 700 (such as corresponding to the terminal equipment 202 in FIG. 2) may include a processor 710 and a memory 720, the memory 720 storing data and a program and being coupled to the processor 710. It should be noted that this figure is illustrative only, and other types of structures may also be used, so as to supplement or replace this structure and achieve a telecommunications function or other functions.

For example, the processor 710 may be configured to execute a program to carry out the method described in the embodiment of the first aspect.

As shown in FIG. 7, the terminal equipment 700 may further include a communication module 730, an input unit 740, a display 750, and a power supply 760; wherein functions of the above components are similar to those in the related art, which shall not be described herein any further. It should be noted that the terminal equipment 700 does not necessarily include all the parts shown in FIG. 7, and the above components are not necessary. Furthermore, the terminal equipment 700 may include parts not shown in FIG. 7, and the related art may be referred to.

FIG. 8 is a schematic diagram of the network device of the embodiment of the fifth aspect. As shown in FIG. 8, the network device 800 (such as corresponding to the network device 201 in FIG. 2) may include a processor 810 (such as a central processing unit (CPU) and a memory 820, the memory 820 being coupled to the processor 810. Wherein, the memory 820 may store various data, and furthermore, it may store a program 830 for information processing, and execute the program 830 under control of the processor 810.

For example, the processor 810 may be configured to execute a program to carry out the method described in the embodiment of the second aspect.

Furthermore, as shown in FIG. 8, the network device 800 may include a transceiver 840, and an antenna 850, etc. Wherein, functions of the above components are similar to those in the related art, and shall not be described herein any further. It should be noted that the network device 800 does not necessarily include all the parts shown in FIG. 8, and furthermore, the network device 800 may include parts not shown in FIG. 8, and the related art may be referred to.

An embodiment of this disclosure provides a computer readable program code, which, when executed in a terminal equipment, will cause the terminal equipment to carry out the method as described in the embodiment of the first aspect.

An embodiment of this disclosure provides a computer readable medium, including a computer readable program code, which will cause a terminal equipment to carry out the method as described in the embodiment of the first aspect.

An embodiment of this disclosure provides a computer readable program code, which, when executed in a network device, will cause the network device to carry out the method as described in the embodiment of the second aspect.

An embodiment of this disclosure provides a computer readable medium, including a computer readable program code, which will cause a network device to carry out the method as described in the embodiment of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

A method at a terminal equipment side:

1. A channel state information generation method, applicable to a terminal equipment, the method including:
receiving a first configuration by the terminal equipment from a network device, the first configuration being used to configure the terminal equipment to transmit channel state information (CSI) to the network device, and the first configuration comprising model information and/or bitwidth information associated with precoding matrix information; and
generating the CSI by the terminal equipment according to a model, the model being determined at least according to the first configuration, and the CSI at least including the precoding matrix information.

2. The method according to supplement 1, wherein the method further includes:
transmitting the CSI by the terminal equipment to the network device.

3. The method according to supplement 1, wherein,
the first configuration includes a CSI report configuration and/or a physical uplink control channel configuration and/or a physical uplink shared channel configuration.

4. The method according to supplement 1, wherein,
the model is an artificial intelligence model.

5. The method according to supplement 1, wherein,
the model is set by the first configuration, and/or the model is determined by the terminal equipment according to the first configuration.

6. The method according to supplement 1, wherein,
the precoding matrix information is associated with spatial layer information.

7. The method according to supplement 1, wherein,
bitwidth information related to the precoding matrix information includes:
a bitwidth of the precoding matrix information, and/or an index of the bitwidth of the precoding matrix information, and/or a maximum value of the bitwidth of the precoding matrix information, and/or an index of the maximum value of the bitwidth of the precoding matrix information.

8. The method according to supplement 1, wherein,
the first configuration further instructs the terminal equipment to report a rank indicator, and the CSI further includes the rank indicator.

9. The method according to supplement 8, wherein,
the terminal equipment further receives a second configuration transmitted by the network device,
the second configuration including third information and/or antenna port information, the third information being used to restrict the rank indicator in the CSI and/or a value to which the rank indicator corresponds.

10. The method according to supplement 1, wherein,
at least a part of the first configuration is the second configuration, or
the first configuration does not include the second configuration.

11. The method according to supplement 8, wherein,
the terminal equipment further receives a third configuration transmitted by the network device,
the third configuration including the third information,
the third configuration including a configuration used for generating the precoding matrix information and/or the CSI,
and the third information being used to restrict the rank indicator in the CSI and/or a value to which the rank indicator corresponds.

12. The method according to supplement 11, wherein,
the third configuration is included in the second configuration, or
the third configuration is not included in the second configuration.

13. The method according to supplement 1, wherein,
the first configuration includes at least one type of bitwidth information and/or model information.

14. The method according to supplement 1, wherein,
the first configuration includes at least two types of the bitwidth information and/or the model information.

15. The method according to supplement 14, wherein,
the precoding matrix information of at least one spatial layer is configured with at least one type of the bitwidth information and/or the model information.

16. The method according to supplement 15, wherein,
for the spatial layer configured with at least two types of the bitwidth information and/or the model information,
the terminal equipment transmits first indication information to the network device, the first indication information being used to indicate bitwidth information and/or model information on which the terminal equipment is based in determining the model.

17. The method according to supplement 14, wherein,
for a value of the rank indicator, the precoding matrix information is configured with at least one type of the bitwidth information and/or the model information.

18. The method according to supplement 17, wherein,
for the value configured with at least two types of bitwidth information and/or model information,
the terminal equipment transmits second indication information to the network device, the second indication information being used to indicate the bitwidth information and/or model information on which the terminal equipment is based in determining the model.

19. The method according to supplement 14, wherein,
at least one spatial layer under at least one value of the rank indicator is configured with at least one type of bitwidth information or model information.

20. The method according to supplement 14, wherein,
the terminal equipment transmits third indication information to the network device, the third indication information being used to indicate the bitwidth information and/or the model information to which the model determined separately by the terminal equipment for each spatial layer corresponds.

21. The method according to supplement 13, wherein,
the terminal equipment receives a fourth configuration from the network device, the fourth configuration being used to configure that,
the models used in each spatial layers are identical, or the models used in at least two spatial layers are different; and/or
for at least two values of the rank indicator, the models used for generating the precoding matrix information corresponding to each value are identical, or the models used for generating the precoding matrix information corresponding to at least two values are different.

22. The method according to supplement 21, wherein,
at least a part of the first configuration is the fourth configuration, or
the first configuration does not include the fourth configuration.

23. The method according to supplement 21, wherein,
the models configured to be used at the spatial layers are identical,
and the terminal equipment transmits fourth indication information to the network device, the fourth indication information being used to indicate information on the determined model.

24. The method according to supplement 21, wherein,
the models configured to be used for at least two spatial layers are different,
and the terminal equipment transmits fifth indication information to the network device, the fifth indication information being used to indicate information on models determined respectively at the spatial layers.

25. The method according to supplement 24, wherein,
a first value to which the rank indicator corresponds is less than the value to which the third information corresponds, and the fifth indication information may include N pieces of the fourth information; where, N is a difference obtained by subtracting the first value from the value to which the third information corresponds.

26. The method according to supplement 25, wherein,
the fourth information is predefined information.

27. The method according to supplement 25, wherein,
the fourth information indicates absence of the model.

A method at a network device side (corresponding to the terminal equipment side):

1. A channel state information configuration method, applicable to a network device, the method including:
transmitting a first configuration by the network device to a terminal equipment, the first configuration being used to configure the terminal equipment to transmit channel state information (CSI) to the network device, and the first configuration comprising model information and/or bitwidth information associated with precoding matrix information,
wherein, the CSI being generated by the terminal equipment according to a model, the model being determined at least according to the first configuration, and the CSI at least comprising the precoding matrix information.

1a. The method according to supplement 1, wherein,
the network device further receives the CSI.

2. The method according to supplement 1, wherein,
the first configuration includes a CSI report configuration and/or a physical uplink control channel configuration and/or a physical uplink shared channel configuration.

3. The method according to supplement 1, wherein,
the model is an artificial intelligence model.

4. The method according to supplement 1, wherein,
the model is set by the first configuration, and/or the model is determined by the terminal equipment according to the first configuration.

5. The method according to supplement 1, wherein,
the precoding matrix information is associated with spatial layer information.

6. The method according to supplement 1, wherein,
bitwidth information related to the precoding matrix information includes:
a bitwidth of the precoding matrix information, and/or an index of the bitwidth of the precoding matrix information, and/or a maximum value of the bitwidth of the precoding matrix information, and/or an index of the maximum value of the bitwidth of the precoding matrix information.

7. The method according to supplement 1, wherein,
the first configuration further instructs the terminal equipment to report a rank indicator, and the CSI further includes the rank indicator.

8. The method according to supplement 7, wherein,
the network device further transmits a second configuration to the terminal equipment,
the second configuration including third information and/or antenna port information, the third information being used to restrict the rank indicator in the CSI and/or a value to which the rank indicator corresponds.

9. The method according to supplement 8, wherein,
at least a part of the first configuration is the second configuration, or
the first configuration does not include the second configuration.

10. The method according to supplement 7, wherein,
the network device further transmits a third configuration to the terminal equipment,
the third configuration including the third information,
the third configuration including a configuration used for generating the precoding matrix information and/or the CSI,
and the third information being used to restrict the rank indicator in the CSI and/or a value to which the rank indicator corresponds.

11. The method according to supplement 10, wherein,
the third configuration is included in the second configuration, or
the third configuration is not included in the second configuration.

12. The method according to supplement 1, wherein,
the first configuration includes at least one type of bitwidth information and/or model information.

13. The method according to supplement 1, wherein,
the first configuration includes at least two types of the bitwidth information and/or the model information.

14. The method according to supplement 13, wherein,
the precoding matrix information of at least one spatial layer is configured with at least one type of the bitwidth information and/or the model information.

15. The method according to supplement 14, wherein,
for the spatial layer configured with at least two types of the bitwidth information and/or the model information,
the network device receives first indication information transmitted by the terminal equipment, the first indication information being used to indicate bitwidth information and/or model information on which the terminal equipment is based in determining the model.

16. The method according to supplement 13, wherein,
for a value of the rank indicator, the precoding matrix information is configured with at least one type of the bitwidth information and/or the model information.

17. The method according to supplement 16, wherein,
for the value configured with at least two types of bitwidth information and/or model information,
the network device receives second indication information transmitted by the terminal equipment, the second indication information being used to indicate the bitwidth information and/or model information on which the terminal equipment is based in determining the model.

18. The method according to supplement 13, wherein,
at least one spatial layer under at least one value of the rank indicator is configured with at least one type of bitwidth information or model information.

19. The method according to supplement 13, wherein,
the network device receives third indication information transmitted by the terminal equipment, the third indication information being used to indicate the bitwidth information and/or the model information to which the model determined separately by the terminal equipment for each spatial layer corresponds.

20. The method according to supplement 12, wherein,
the network device transmits a fourth configuration to the terminal equipment, the fourth configuration being used to configure that,
the models used in each spatial layers are identical, or the models used in at least two spatial layers are different; and/or
for at least two values of the rank indicator, the models used for generating the precoding matrix information corresponding to each value are identical, or the models used for generating the precoding matrix information corresponding to at least two values are different.

21. The method according to supplement 20, wherein,
at least a part of the first configuration is the fourth configuration, or
the first configuration does not include the fourth configuration.

22. The method according to supplement 20, wherein,
the models configured to be used at the spatial layers are identical,
and the network device receives fourth indication information transmitted by the terminal equipment, the fourth indication information being used to indicate information on the determined model.

23. The method according to supplement 20, wherein,
the models configured to be used for at least two spatial layers are different,
and the network device receives fifth indication information transmitted by the terminal equipment, the fifth indication information being used to indicate information on models determined respectively at the spatial layers.

24. The method according to supplement 23, wherein,
a first value to which the rank indicator corresponds is less than the value to which the third information corresponds, and the fifth indication information includes N pieces of the fourth information; where, N is a difference obtained by subtracting the first value from the value to which the third information corresponds.

25. The method according to supplement 24, wherein,
the fourth information is predefined information.

26. The method according to supplement 24, wherein,
the fourth information indicates absence of the model.

1. A channel state information generation apparatus, applicable to a terminal equipment, the apparatus comprising:
first processor circuitry controlling the terminal equipment, the first processor circuitry configured to:
receive a first configuration by the terminal equipment from a network device, the first configuration being used to configure the terminal equipment to transmit channel state information (CSI) to the network device, and the first configuration comprising model information and/or bitwidth information associated with precoding matrix information; and
generate the CSI by the terminal equipment according to a model, the model being determined at least according to the first configuration, and the CSI at least comprising the precoding matrix information.

2. The apparatus according to claim 1, wherein,
the first configuration comprises a CSI report configuration and/or a physical uplink control channel configuration and/or a physical uplink shared channel configuration.

3. The apparatus according to claim 1, wherein,
the model is set by the first configuration, and/or the model is determined by the terminal equipment according to the first configuration.

4. The apparatus according to claim 1, wherein,
the precoding matrix information is associated with spatial layer information.

5. The apparatus according to claim 1, wherein,
the first configuration further instructs the terminal equipment to report a rank indicator, and the CSI further comprises the rank indicator.

6. The apparatus according to claim 5, wherein,
the terminal equipment further receives a second configuration transmitted by the network device,
the second configuration comprising third information and/or antenna port information, the third information being used to restrict the rank indicator in the CSI and/or a value to which the rank indicator corresponds.

7. The apparatus according to claim 5, wherein,
the terminal equipment further receives a third configuration transmitted by the network device,
the third configuration comprising third information,
the third configuration comprising a configuration used for generating the precoding matrix information and/or the CSI,
and the third information being used to restrict the rank indicator in the CSI and/or a value to which the rank indicator corresponds.

8. The apparatus according to claim 1, wherein,
the first configuration comprises at least one type of bitwidth information and/or model information.

9. The apparatus according to claim 1, wherein,
the first configuration comprises at least two types of the bitwidth information and/or the model information.

10. The apparatus according to claim 9, wherein,
the precoding matrix information of at least one spatial layer is configured with at least one type of the bitwidth information and/or the model information.

11. The apparatus according to claim 10, wherein,
for the spatial layer configured with at least two types of the bitwidth information and/or the model information,
the terminal equipment transmits first indication information to the network device, the first indication information being used to indicate the bitwidth information and/or the model information on which the terminal equipment is based in determining the model.

12. The apparatus according to claim 9, wherein,
the terminal equipment transmits third indication information to the network device, the third indication information being used to indicate the bitwidth information and/or the model information to which the model determined separately by the terminal equipment for each spatial layer corresponds.

13. The apparatus according to claim 8, wherein,
the terminal equipment receives a fourth configuration from the network device, the fourth configuration being used to configure that,
the models used in each spatial layer are identical, or the models used in at least two spatial layers are different; and/or
for at least two values of rank indicator, the models used for generating the precoding matrix information corresponding to each value are identical, or the models used for generating the precoding matrix information corresponding to at least two values are different.

14. A channel state information configuration apparatus, applicable to a network device, the apparatus comprising:
second processor circuitry controlling the network device, the second processor circuitry configured to:
transmit a first configuration by the network device to a terminal equipment, the first configuration being used to configure the terminal equipment to transmit channel state information (CSI) to the network device, and the first configuration comprising model information and/or bitwidth information associated with precoding matrix information,
wherein, the CSI being generated by the terminal equipment according to a model, the model being determined at least according to the first configuration, and the CSI at least comprising the precoding matrix information.

15. The apparatus according to claim 14, wherein,
the first configuration further instructs the terminal equipment to report a rank indicator, and the CSI further comprises the rank indicator.

16. The apparatus according to claim 15, wherein,
the network device further transmits a second configuration to the terminal equipment,
the second configuration comprising third information and/or antenna port information, the third information being used to restrict the rank indicator in the CSI and/or a value to which the rank indicator corresponds.

17. The apparatus according to claim 15, wherein,
the network device further transmits a third configuration to the terminal equipment,
the third configuration comprising a configuration used for generating the precoding matrix information and/or the CSI,
and the third information being used to restrict the rank indicator in the CSI and/or a value to which the rank indicator corresponds.

18. The apparatus according to claim 14, wherein,
the first configuration comprises at least two types of the bitwidth information and/or the model information.

19. The apparatus according to claim 18, wherein,
the precoding matrix information of at least one spatial layer is configured with at least one type of the bitwidth information and/or the model information.

20. The apparatus according to claim 19, wherein,
for the spatial layer configured with at least two types of the bitwidth information and/or the model information,
the network device receives first indication information transmitted by the terminal equipment, the first indication information being used to indicate bitwidth information and/or model information on which the terminal equipment is based in determining the model.
